(19) United States
(12) Patent Application Publication
(10) Pub. No.: US 2003/0053857 A1
(43) Pub. Date: Mar. 20, 2003

(54) Spring leg shaft retainer

(76) Inventors: Jeffrey D. Anderson, S. Elgin, IL (US); Kent D. Homfeldt, Elgin, IL (US)

Correspondence Address: PAUL F. DONOVAN, ILLINOIS TOOL WORKS INC., 3600 WEST LAKE AVENUE, GLENVIEW, IL, 60025, US

(21) Appl. No.: 10/245,481

(22) Filed: Sep. 18, 2002

Related U.S. Application Data
(60) Provisional application No. 60/322,991, filed on Sep. 18, 2001.

(51) Int. Cl. F16B 1/00

(52) U.S. Cl. 403/317

(57) ABSTRACT

A shaft retainer particularly suitable for securing bearings on a motor shaft, the retainer having an annular core with a central opening for engaging the shaft in an interference fit, and a plurality of equally spaced biasing elements about the periphery of the core.

### CROSS-REFERENCE TO RELATED APPLICATION

This application claims benefit to United States provisional application Serial No. 60/322,991 filed on Sep. 18, 2001.

### FIELD OF THE INVENTION

The present invention relates generally to retainers provided for securing the axial positions of elements on shafts, and, more particularly, to a motor bearing retainer secured on a motor shaft by interference fit.

### BACKGROUND OF THE INVENTION

Different types of retaining mechanisms are known for securing the axial positions of elements on shafts. For example, outboard retainers are used to secure bearings on shafts of motors. The bearing is restrained on the inboard side thereof by other structure, such as the motor housing or other physical restraint, and a retainer is tightened against the bearing on the outboard side thereof to fix the axial position of the bearing on the motor shaft. The bearing is fixed in position on the shaft between the inboard restraint and the outboard retainer.

Threaded and keyed retainers are known for such applications. Each can be difficult to install, slowing the assembly process. Push-on type retainers are also known, structured to allow relatively easy movement of the retainer along a shaft in one direction, while resisting movement of the retainer along the shaft in the opposite direction. Push-on assembly is frequently easier and quicker than assembly using other types of retainers is.

For some shaft assemblies, it is desirable to provide a predetermined compressive force against the element on the shaft, and to provide an even distribution of the force about the circumference of the shaft. It is known to use spring washers for such application needs. A disadvantage in using a discrete spring washer in conjunction with the retainer is that separate discrete elements are more cumbersome and difficult to install, and thereby can prolong the assembly process and increase the cost of assembly.

Simplifying installation and providing inexpensive, cost efficient components are target goals in retainer design, particularly for devices used in great numbers. Even small savings in the cost of supplying the necessary parts, and/or the final assembly can achieve significant annual overall cost benefits.

What is needed in the art is a shaft retainer having an integral biasing mechanism to combine the biasing and retaining function in a single integrated unit that can be installed quickly and easily.

### SUMMARY OF THE INVENTION

The present invention provides a shaft retainer that can be installed by sliding the retainer onto the shaft, such as a motor shaft, and that has integrally formed therewith biasing elements for providing compressive force against elements on the shaft.

In one aspect thereof, the invention provides a shaft retainer with a core having a first face, a second face and an outer surface. The core defines an opening therethrough. The opening is shaped to surround a shaft in an interference fit relationship. A plurality of biasing elements is connected to the core along the outer surface. The biasing elements each have a flex portion extending beyond one of the first face and the second face in a relaxed state.

In another aspect thereof, the invention provides a bearing retainer for securing a bearing on a motor shaft. An annular body has a central opening for sliding on a shaft. The central opening is shaped for engaging the shaft with an interference fit inhibiting removal of the body from the shaft. A biasing means is integral with the body for applying a pre-established force against the bearing on the shaft.

In still another aspect thereof, the invention provides a shaft assembly with a shaft, an element slidably disposed on the shaft, and a retainer for securing the element on the shaft. The retainer has an annular body with a central opening for sliding on the shaft. The central opening is shaped for engaging the shaft with an interference fit inhibiting removal of the body from the shaft. A plurality of spring arms is integral with the body for applying a pre-established force against the element on the shaft. Each spring arm is arcuately shaped and disposed adjacent the annular body, and has an anchor portion integral with the body and a flex portion integrally connected with the anchor portion thereof, the flex portion being discrete from the annular body.

An advantage of the present invention is providing a single structure incorporating both a retainer and biasing functions in an integral unit.

Another advantage of the present invention is providing a shaft retainer that can be installed quickly and easily, and that can be manufactured in a cost efficient manner.

Yet another advantage of the present invention is providing a shaft retainer that provides evenly distributed biasing force against elements on the shaft, and that can be manufacture and provided to a predetermined biasing force.

Still another advantage of the present invention is providing a shaft retainer that is easily installed and inhibits sliding of the retainer from the shaft on which it is installed.

Other features and advantages of the invention will become apparent to those skilled in the art upon review of the following detailed description, claims and drawings, in which like numerals are used to designate like features.

### BRIEF DESCRIPTION OF THE DRAWINGS

FIG. 1 is an elevational view of a shaft and retainer assembly in accordance with the present invention; and

FIG. 2 is a perspective view of the retainer of the present invention.

Before the embodiments of the invention are explained in detail, it is to be understood that the invention is not limited in its application to the details of construction and the arrangements of the components set forth in the following description or illustrated in the drawings. The invention is capable of other embodiments and of being practiced or being carried out in various ways. Also, it is understood that the phraseology and terminology used herein are for the purpose of description and should not be regarded as limiting. The use of “including” and “comprising” and variations thereof herein is meant to encompass the items listed thereafter and equivalents thereof as well as additional items and equivalents thereof.

### DETAILED DESCRIPTION OF THE PREFERRED EMBODIMENT

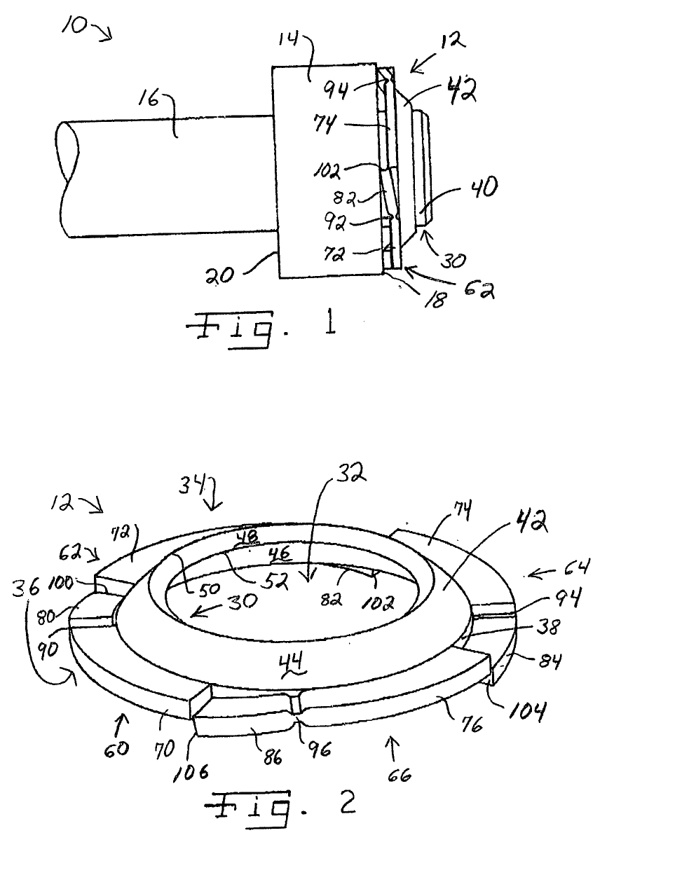

Referring now more specifically to the drawing, and to FIG. 1 in particular, a shaft assembly 10 is shown which includes retainer 12 in accordance with the present invention. Retainer 12 is provided for securing an element 14, such as a bearing 14, on a shaft 16, such as a motor shaft 16. Retainer 12 is provided on an outboard side 18 of element 14 while an inboard side 20 thereof is axially restrained on shaft 16 by a shoulder (not shown) or the like.

Alternatively, inboard side 20 of element 14 can be restrained by a housing (not shown) in which the shaft and element 14 are positioned.

Retainer 12 includes a core 30 in the nature of an annular body having a central opening 32 for sliding on shaft 16. Core 30 has a first side 34 and a second side 36, and defines an essentially circular perimeter or outer surface 38 of a sidewall 40. It should be understood that while core 30 is described and shown herein as an annular body, in some applications of the present invention outer surface may be shaped other than circular. So also, central opening 32 may be shaped and sized to accommodate a shaft 16 having other than a circular cross-section in the region at which retainer 12 is to be installed. The present invention can be used equally well for such applications.

First side 34 of core 30 includes a frustuconically shaped top 42. Top 42 projects inwardly and axially away from sidewall 40 in defining the frustuconical shape of top 42. Thus, top 42 has annular inwardly directed outer face 44 and inner face 46, relative to sidewall 40. A distal face 48 of top 42 has an outer edge 50 and an inner edge 52, with outer edge 50 being of slightly greater diameter than inner edge 52.

A plurality of biasing elements 60, 62, 64 and 66 are provided at outer surface 38, each biasing element 60, 62, 64 and 66 having a portion thereof integral with outer surface 38. In the exemplary embodiment, four biasing elements 60, 62, 64 and 66 are provided for retainer 12. Biasing elements 60, 62, 64 and 66 are provided equally spaced about outer surface 38 such that an evenly distributed biasing force is provided by retainer 12 against element 14 when both are installed on shaft 16. Biasing elements 60, 62, 64 and 66 are in the nature of spring arms, each having an anchor portion 70, 72, 74, 76, respectively, and a flex portion 80, 82, 84, 86, respectively. Anchor portions 70, 72, 74, 76 are separated from flex portions 80, 82, 84, 86 by hinge portions 90, 92, 94, 96, respectively, in the nature of thinned areas between the respective anchor portions and flex portions.

Biasing elements 60, 62, 64, 66 are arcuately shaped structures extending around and adjacent core 30, at outer surface 38 thereof. While anchor portions 70, 72, 74 and 76 are integral with, or fixedly connected to outer surface 38, flex portions 80, 82, 84 and 86 lie adjacent outer surface 38, but are not joined thereto.

Thus, flex portions 80, 82, 84 and 86 are discrete from and can move relative to outer surface 38, whereas anchor portions 70, 72, 74 and 76 can not move relative to outer surface 38.

Flex portions 80, 82, 84, 86 are integral with hinge portions 90, 92, 94 and 96, respectively, and thereby are connected to anchor portions 70, 72, 74 and 76, respectively. Biasing elements 60, 62, 64 and 66 are bent at hinge portions 90, 92, 94 and 96 such that flex portions 80, 82, 84 and 86 are angled relative to anchor portions 70, 72, 74 and 76, respectively. As a result, ends 100, 102, 104 and 106 extend beyond second side 34 of core 30, when biasing elements 60, 62, 64 and 66 are in a relaxed state.

Advantageously, the material selected for retainer 12, the shaping of flex portions 80, 82, 84, 86 and of hinged portions 90, 92, 94, 96 are selected along with the degree of deflection at hinged portions 90, 92, 94, 96 to provide a predetermined biasing force against an element 14 against which retainer 12 is installed.

As those in the art will understand readily, retainer 12 advantageously is made of metal or the like, and can be stamped from a plate-like portion of the desired material. Biasing element 60, 62, 64, 66 can be formed from a flange about core 30, with each flex portion 80, 82, 84, 86 thereof separated from the adjacent anchor portion 70, 72, 74, 76 by hinge portions 90, 92, 94 and 96, respectively. Distal face 48, and particularly inner edge 52 thereof, is sized to fit snuggly on shaft 16, with inner edge 52 engaging shaft 16 so as to provided the retentive force securing retainer 12 on shaft 16, as will be described more fully hereinafter.

In the use of retainer 12 in accordance with the present invention, element 14 is installed on shaft 16 with inboard side 20 thereof fixed in position. Retainer 12 is positioned in alignment with shaft 16, with an end of shaft 16 extended through central opening 32 of core 30. Axially force applied to retainer 16, directed toward element 14, causes retainer 12 to slide along shaft 16 until ends 100, 102, 104 and 106 of biasing element 60, 62, 64, 66 engage against outboard side 18 of element 14. Continued force applied on retainer 12 in the direction toward element 14, causes flex portions 80, 82, 84 and 86 to bend at hinge portions 90, 92, 94 and 96, applying a predetermined load against element 14.

The frustuconical shape of top 42 allows retainer 12 to be slid toward element 14 from the application of relatively less force than the force required to pull retainer 12 away from element 14. When retainer 12 is drawn in the removal direction away from element 14, inner edge 52 of inner face 46 bites into the surface of shaft 16, to resist removal of retainer 12 from shaft 16. Thus, retainer 12 is both easy to install and relatively more difficult to remove from shaft 16.

It should be understood that while four biasing elements 60, 62, 64, 66 have been shown and described herein, the present invention is not limited to a specific number of biasing elements 60, 62, 64, 66. Thus, both more than four and less than four biasing elements 60, 62, 64, 66 are including within the scope of the present invention. Further, while flex portions 80, 82, 84 and 86 are shown minimally spaced from outer surface 38, one or more of flex portions 80, 82, 84 and 86 can be angled away from surface 38, to provide some significant spacing between surface 38 and one or more of ends 100, 102, 104 and 106.

Variations and modifications of the foregoing are within the scope of the present invention. It is understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention. The claims are to be construed to include alternative embodiments to the extent permitted by the prior art.

Various features of the invention are set forth in the following claims.

What is claimed is:

1. A shaft retainer comprising:
a core having a first face, a second face and an outer surface, said core defining an opening therethrough, said opening shaped to surround a shaft in an interference fit relationship; and
a plurality of biasing elements connected to said core along said outer surface, said biasing elements each having a flex portion extending beyond one of said first face and said second face in a relaxed state.

2. The retainer of claim 1, said biasing elements being evenly spaced about said outer surface of said core.

3. The retainer of claim 2, including four said biasing elements.

4. The retainer of claim 1, said core being annular, with said outer surface being generally circular, and said biasing elements being evenly spaced about said outer surface.

5. The retainer of claim 4, each said biasing element being arcuately shaped and having an anchor portion integrally joined to said core along a part of said outer surface and a flex end portion discrete from said outer surface, each said end portion deflected in a common direction beyond one of said first face and second face.

6. The retainer of claim 5, including four said biasing elements.

7. The retainer of claim 5, each said biasing element having a resilient hinge portion between said anchor portion and said flex portion thereof.

8. The retainer of claim 5, each said biasing element having a thinned hinged portion joining said flex portion to said anchor portion thereof.

9. The retainer of claim 5, the other of said first face and said second face being frustuconically shaped, and being adapted to slide along a shaft as a force is applied to said retainer in a direction of said one face; and to resist movement on a shaft when force is applied toward said other face.

10. The retainer of claim 7, said other face defining an edge for engaging a shaft in said opening.

11. A bearing retainer for securing a bearing on a motor shaft, comprising:
an annular body having a central opening for sliding on a shaft, said central opening shaped for engaging the shaft with an interference fit inhibiting removal of said body from the shaft; and
a biasing means integral with said body for applying a pre-established force against the bearing on the shaft.

12. The bearing retainer of claim 11, said biasing means including four spring arms.

13. The bearing retainer of claim 12, each said spring arm being arcuately shaped and disposed adjacent said annular body, and each spring arm having an anchor portion integral with said body and a flex portion integrally connected with said anchor portion thereof, and discrete from said annular body.

14. The bearing retainer of claim 13, each said spring arm including a thinned hinge portion between said anchor portion thereof and said flex portion thereof.

15. The bearing retainer of claim 14, said spring arms equally spaced about said annular body.

16. The bearing retainer of claim 15, said body having a frustuconically shaped face with an inner edge adapted to engage the shaft.

17. The bearing retainer of claim 11 said body having a frustuconically shaped face with an inner edge adapted to engage the shaft.

18. A shaft assembly, comprising:
a shaft;
an element slidably disposed on said shaft; and
a retainer for securing said element on said shaft, said retainer comprising:
an annular body having a central opening for sliding on said shaft, said central opening shaped for engaging said shaft with an interference fit inhibiting removal of said body from said shaft; and
a plurality of spring arms integral with said body for applying a pre-established force against said element on said shaft, each said spring arm being arcuately shaped and disposed adjacent said annular body, and each spring arm having an anchor portion integral with said body and a flex portion integrally connected with said anchor portion thereof, said flex portion being discrete from said annular body.

19. The shaft assembly of claim 18, said plurality of spring arms including four spring arms evenly spaced around said annular body.

20. The shaft assembly of claim 19, said shaft being a motor shaft and said element being a bearing.
